(19) United States
(12) Patent Application Publication
(10) Pub. No.: US 2007/0118808 A1
(43) Pub. Date: May 24, 2007

(54) Computer system and OSD displaying method with user configurable function

(75) Inventors: Min-Jye Chen, Miaoli City (TW); Yi-Hsiang Kao, Lujhu Township (TW); Chiu-Huang Weng, Yingge Township (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/603,155

(22) Filed: Nov. 22, 2006

(30) Foreign Application Priority Data
Nov. 24, 2005 (TW) 94141348

(51) Int. Cl. G06F 3/00

(52) U.S. Cl. 715/764

(57) ABSTRACT

A displaying method of an on screen display (OSD) system is provided. The method is used in a computer system which includes a host and a display device. The display device has a screen, a display micro-processor and a storage unit. An original OSD parameter is stored in the storage unit. The method includes the following steps. Firstly, an OSD compiler is provided in a host for being displayed on the screen. Next, after a user adjusts the display characteristics of the OSD, the OSD compiler generates a modified OSD parameter. Then, the modified OSD parameter is inputted to the display micro-processor. Next, the modified OSD parameter is stored to the storage unit by the display micro-processor. Lastly, when the screen re-displays the OSD, the OSD is displayed on the screen according to the modified OSD parameter.

This application claims the benefit of Taiwan application Serial No. 94141348, filed Nov. 24, 2005, the subject matter of which is incorporated herein by reference.

### BACKGROUND OF THE INVENTION

1. Field of the Invention

The invention relates in general to an on screen display (OSD) displaying method, and more particularly to an OSD displaying method with user configurable function.

2. Description of the Related Art

Display device such as TV or computer screen always has a number of buttons. By pressing the buttons, the user can control display characteristics such as brightness, color, sound, and the level and verticality of window. The interface for controlling the above characteristics is called on screen display (OSD) compiler.

Referring to FIG. 1, a conventional flowchart of generating an OSD compiler is shown. The method includes the following steps. Firstly, the method begins at step 101, a programming code is edited in a programming developing environment. Next, in step 103, the programming code is compiled into a machine code by a compiler. Then, in step 105, different programs are linked to position the machine code. Lastly, in step 107, the machine code is recorded in a display micro-processor of the display device. As for the user, the OSD disposition and the relative positions of the icons of OSD parameters such as brightness, sound and color are fixed on the display of the display device. For example, the brightness icon is positioned besides the color icon, and the level and verticality icon is positioned besides the sound icon. The user cannot change the relative positions of different icons, largely affecting the friendliness and practicality of the OSD operation.

### SUMMARY OF THE INVENTION

The invention is directed to an on screen display (OSD) displaying method with user configurable function for enabling the user to design the OSD display according to personal needs.

According to an aspect of the invention, a displaying method of an on screen display (OSD) system is provided. The method is used in a computer system which includes a host and a display device. The display device has a screen, a display micro-processor and a storage unit. An original OSD parameter is stored in the storage unit. The method includes the following steps. Firstly, an OSD compiler is provided in a host for being displayed on the screen. Next, after a user adjusts the display characteristics of the OSD, the OSD compiler generates a modified OSD parameter. Then, the modified OSD parameter is inputted to the display micro-processor. Next, the modified OSD parameter is stored to the storage unit by the display micro-processor. Lastly, when the screen re-displays the OSD, the OSD is displayed on the screen according to the modified OSD parameter

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a conventional flowchart of generating an OSD compiler;

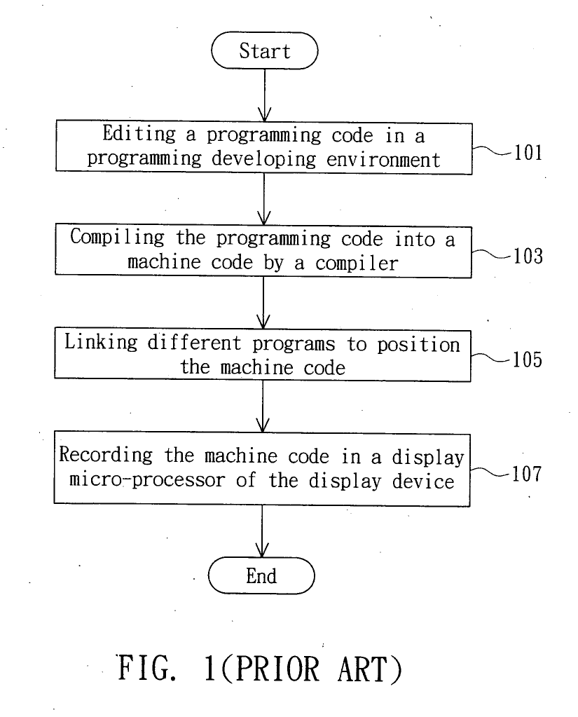

FIG. 2A shows a computer system using an OSD displaying method of the invention;

FIG. 2B is a block diagram of the computer system in FIG. 2A;

FIG. 3 is a flowchart of an OSD displaying method; and

FIG. 4 shows a modified OSD display.

### DETAILED DESCRIPTION OF THE INVENTION

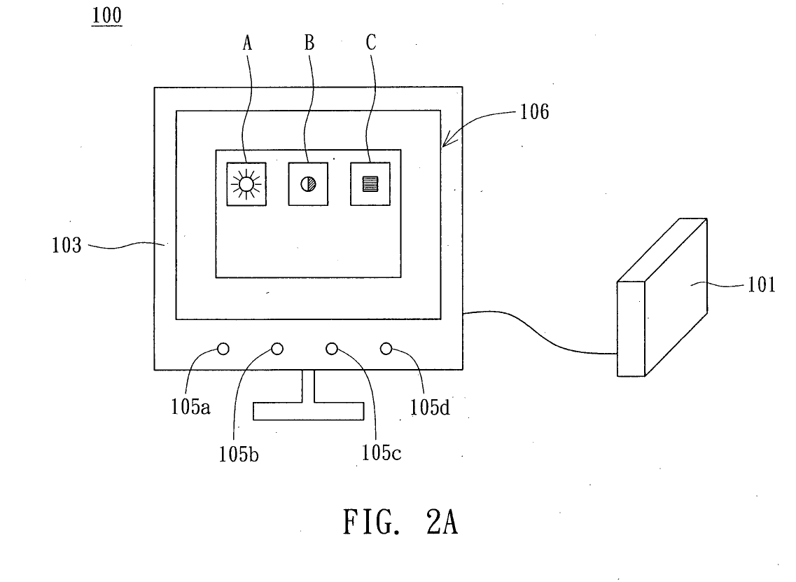

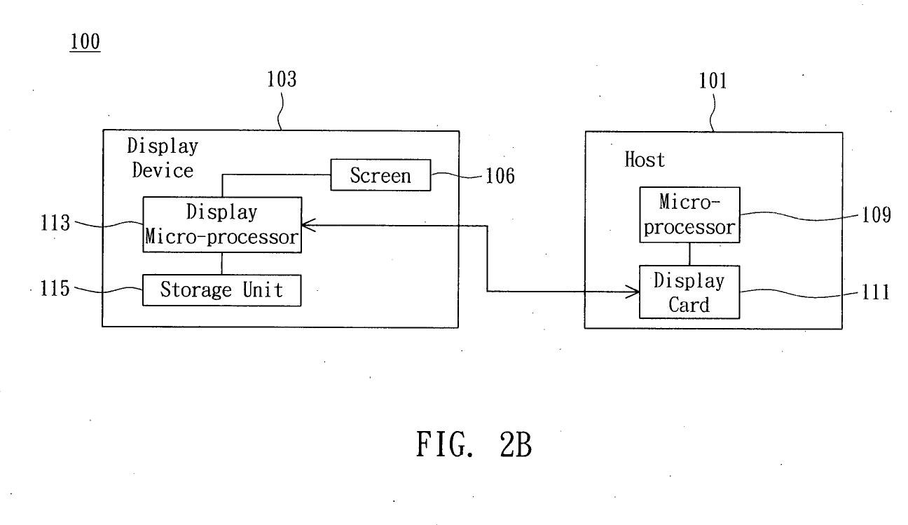

Referring to FIG. 2A and FIG. 2B, FIG. 2A shows a computer system using an OSD displaying method of the invention, while FIG. 2B is a block diagram of the computer system in FIG. 2A. The computer system 100 includes a host 101 and a display device 103. The host 101 has a micro-processor 109 and a display card 111. The display device 103 includes a display micro-processor 113, a storage unit 115 and a screen 106. There are a number of buttons, such as buttons 105a-105d, disposed on the display device 103. The buttons 105a-105d are used for controlling the settings of the OSD to change the display characteristics of the display device 103. As shown in FIG. 2A, the OSD may have three icons A, B and C respectively controlling the brightness, the color and the sound of the display device 103. The user can adjust the display characteristics of the display device 103, such as brightness, color and sound, by controlling the buttons 105a-105d.

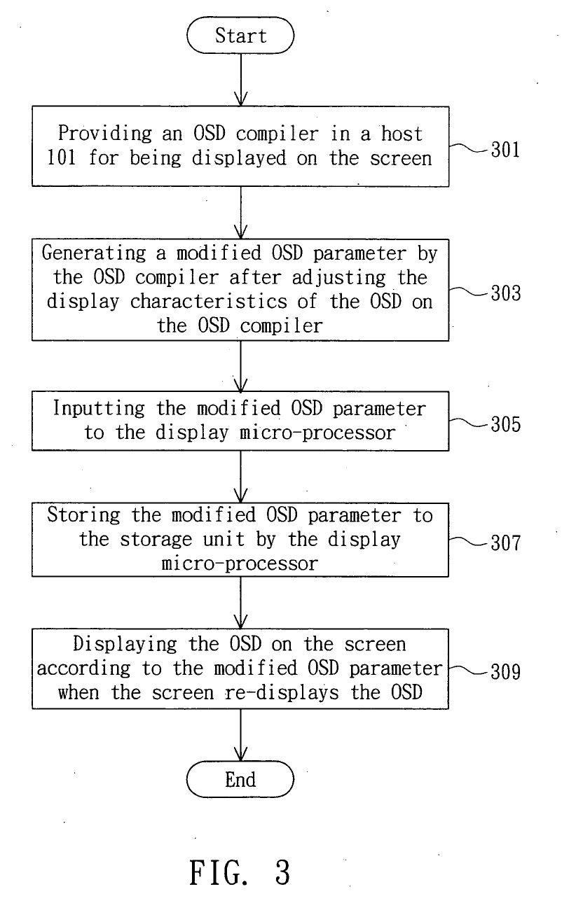

Referring to FIG. 3, a flowchart of an OSD displaying method is shown. The method includes the following steps. Firstly, the method begins at step 301, an OSD compiler 107 is provided in a host 101 for being displayed on the screen 106. Next, in step 303, after a user adjusts the display characteristics of the OSD on the OSD compiler 107 to modify the original OSD parameter, the OSD compiler 107 generates a modified OSD parameter. Then, in step 305, the modified OSD parameter is inputted to the display micro-processor 113. Then, in step 307, the modified OSD parameter is stored to the storage unit by the display micro-processor 113. Lastly, in step 309, when the screen re-displays the OSD, the OSD is displayed on the screen according to the modified OSD parameter.

In step 301, the user may load the OSD compiler to the host by an optical disc drive. The OSD compiler can be programmed in Visual Basic, Visual C++, or other programming languages. After the OSD compiler is activated, the display device 103 displays the OSD compiler 107. Meanwhile, the user may set the OSD compiler 107 and adjusts the display characteristics of the OSD according to personal preferences such as the style, the pattern, the size and the position of OSD icons. The pattern of the icon may be drawn using drawing software or selected from a database via a link.

In step 303, after the display characteristics of the OSD are adjusted, the original OSD parameter is updated and replaced. In step 305, examples of the transmission to the display micro-processor 113 include cable transmission and wireless transmission. In terms of cable transmission, the modified OSD parameter can be transmitted to a second transmission interface of the display micro-processor via a first transmission interface of the host. Examples of the first transmission interface and the second transmission interface include DDCCI transmission interface of display card or other transmission interfaces such as RS-232 or I2C.

Examples of the first transmission interface and the second transmission interface include wireless transmission interface such as blue tooth transmission interface. In terms of wireless transmission interface, the first transmission interface and the second transmission interface can be disposed in two transmitters for respectively transmitting and receiving the OSD parameter. Examples of the storage unit include the memory device with storage function such as DRAM, SRAM or EEPROM. Preferably, the storage unit is an EEPROM.

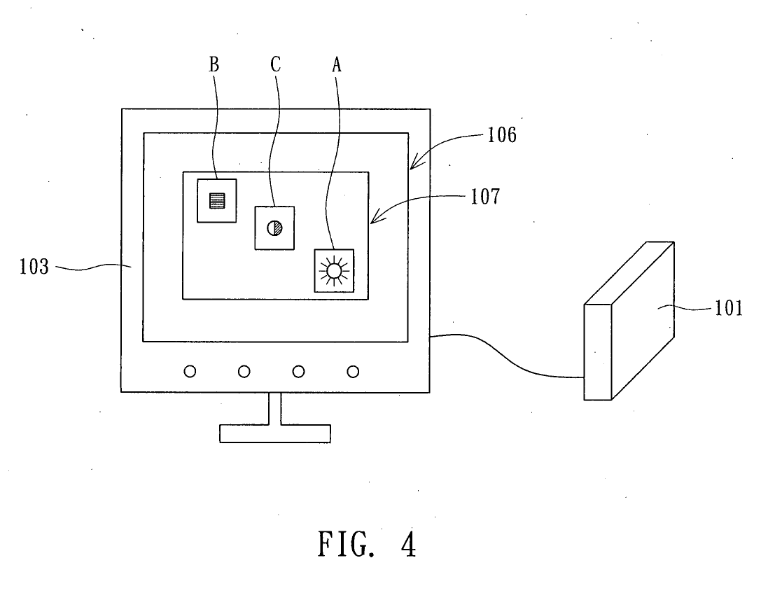

Referring to both FIG. 2A and FIG. 4, FIG. 4 shows a modified OSD display. In step 309, when the screen re-displays the OSD, the display device displays the OSD according to the modified OSD parameter. For example, as shown in FIG. 4, in the modified OSD display, the arrangement of the icons is adjusted from A-B-C to B-C-A, meanwhile, the OSD disposition in the modified OSD display is also different from that of original OSD disposition. The user may use the preview function of the OSD compiler to preview the resulted display.

According to the computer system and the OSD displaying method disclosed in the above embodiment of the invention, a user-friendly OSD compiler is for the user to compile the OSD display. A user lacking of programming abilities is still able to compile the OSD display, hence improving the friendliness and competiveness of the system and the electronic product.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A displaying method of an on screen display (OSD) system, wherein the method is used in a computer system comprising a host and a display device, the display device has a screen, a display micro-processor and a storage unit, the storage unit stores an original OSD parameter, the method comprises:
providing an OSD compiler in a host for being displayed on the screen generating a modified OSD parameter by the OSD compiler after modifying the original OSD parameter on the OSD compiler;
inputting the modified OSD parameter to the display micro-processor;
storing the modified OSD parameter to the storage unit by the display micro-processor; and
displaying the OSD on the screen according to the modified OSD parameter when the screen re-displays the OSD.

2. The method according to claim 1, wherein after the step of inputting the modified OSD parameter, the displaying method further comprises:
transmitting the modified OSD parameter to a second transmission interface of the display device by a first transmission interface of the host; and
storing the modified OSD parameter inputted by the second transmission interface to the storage unit.

3. The method according to claim 2, wherein the first transmission interface and the second transmission interface are blue tooth transmission interfaces.

4. The method according to claim 2, wherein there is the first transmission interface and the second transmission interface are RS-232 transmission interfaces.

5. A computer system, comprising:
a host for executing an OSD compiler, wherein the host comprises a micro-processor used for generating and outputting an original OSD parameter of the OSD compiler; and
a display device electrically connected to the host, wherein the display device comprises:
a display micro-processor for receiving the original OSD parameter transmitted by the display card;
a storage unit for storing the original OSD parameter processed by the display micro-processor; and
a screen having a plurality of buttons, wherein the screen is for displaying a frame;
wherein when a user compiles the OSD compiler, the original OSD parameter is updated as a modified OSD parameter, which is stored in the storage unit via the micro-processor, the transmission interface and the display micro-processor;
wherein when one of the buttons of the screen is activated, the screen displays an updated frame.

6. The system according to claim 5, wherein the host further has a first transmission interface, and the original OSD parameter or the modified OSD parameter are transmitted to the storage unit via the first transmission interface.

7. The system according to claim 6, wherein the first transmission interface is a DDCCI transmission interface.

8. The system according to claim 6, wherein the first transmission interface is an RS-232 transmission interface.

9. The system according to claim 6, wherein the host further has a second transmission interface between the first transmission interface and the storage unit, the original OSD parameter or the modified OSD parameter are transmitted to the storage unit via the first transmission interface and the second transmission interface.

10. The system according to claim 9, wherein the first transmission interface and the second transmission interface comply with blue tooth transmission interface protocol.
